(19) United States
(12) Patent Application Publication
(10) Pub. No.: US 2006/0071889 A1
(43) Pub. Date: Apr. 6, 2006

(54) Touch-input-integrated liquid crystal display panel

(75) Inventors: Kei-Hsiung Yang, Taoyuan City (TW); Wei-Chou Chen, Hsinchu City (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: Hannstar Display Corporation, Taipei (TW)

(21) Appl. No.: 11/075,597

(22) Filed: Mar. 9, 2005

(30) Foreign Application Priority Data
Oct. 1, 2004 (TW) 093129931

(51) Int. Cl. G09G 3/36

(52) U.S. Cl. 345/87

(57) ABSTRACT

The present invention provides a touch-input-integrated liquid crystal display panel having a pattern unit with a coding arrangement. The pattern unit with the coding arrangement is integrated into the panel by one of the three ways of (1) disposing the pattern unit on the polarizer, (2) disposing the pattern unit on the upper substrate of the panel corresponding to the black matrix, and (3) disposing the pattern unit on the upper substrate of the panel not limited to be corresponding to the black matrix, wherein the pattern unit is made of a denser optical medium or a less dense optical medium, the depth of the pattern unit multiplied the refractive index of the medium is about (N+¼)-folds of the wavelength of the infrared ray, and furthermore the pattern unit can also be multiple-layer structure, a single-layer cholesteric liquid crystalline film or a multiple-layer structure wherein at least one layer is made of a cholesteric liquid crystalline film.

### FIELD OF THE INVENTION

The present invention relates to a touch input liquid crystal display panel, and more particularly to a liquid crystal display panel having pattern units with a coding arrangement.

### BACKGROUND OF THE INVENTION

As the digital information is popularized, the conventional way for inputting the information to a device is gradually replaced by the touch input technology.

Conventionally, the touch input devices include sensors based on a resistance and sensors based on a capacitance, i.e. the touched position on the touch input device is identified by measuring the electrical potential changes caused by a touch via a circuit.

Recently, the optical touch input technology is developed, i.e. the touched position is identified by identifying the optical images. For the optical touch input device, the position information can be entered by writing with a light pen that illuminates and detects a specific position-coding arrangement fabricated on the substrate of the optical touch input device. The coding arrangement is exposed to the light emitted from the light pen, and then the light is reflected to the image-detecting system located with the light pen. Then, the touch position is obtained by decoding the detected images.

For the display panel with the conventional touch input devices based on resistive or capacitive effects, the optical quality of the display is decreased due to transmission loss caused by the addition of the touch input devices. In addition, due to the touch input device externally added to the display panel, not only the weight of the whole display system is increased, but also the structure responsible to the change of electrical signals upon touch is easily damaged, so that there are often errors in the identification of the touch position.

In order to overcome the foresaid drawbacks in the prior arts, the present invention provides a touch-input-integrated liquid crystal dispay panel.

### SUMMARY OF THE INVENTION

It is an aspect of the present invention to provide a touch-input-integrated liquid crystal display panel having at least a pattern unit therein, wherein the pattern unit has the coding arrangement, and thereby the panel has great optical quality and the coding arrangement is well protected. Compared with the external touch input device added on the conventional liquid crystal display panel, the touch-input-integrated liquid crystal display panel of the present invention is lighter.

It is another aspect of the present invention to provide a touch-input-integrated liquid crystal display panel having at least a pattern unit with the coding arrangement for intensively reflecting the infrared ray incident on the panel, and thereby a position of the panel, where the infrared ray is incident upon is obtained by detecting the reflected infrared ray and decoding the coding arrangement.

It is another aspect of the present invention to provide a polarizer having at least a pattern unit with the coding arrangement for intensively reflecting the infrared ray incident on the polarizer.

It is another aspect of the present invention to provide a substrate having at least a pattern unit with the coding arrangement for intensively reflecting the infrared ray incident on the substrate.

The above aspects and advantages of the present invention will become more readily apparent to those ordinarily skilled in the art after reviewing the following detailed description and accompanying drawings, in which:

### BRIEF DESCRIPTION OF THE DRAWINGS

FIG. 1(a) is a schematic view illustrating the pattern unit with the coding arrangement formed on the polarizer according to the present invention, wherein the polarizer is disposed at the boundary between the first supporting layer 11 and the protective layer 10;

FIG. 1(b) is a schematic view illustrating the pattern unit with the coding arrangement formed on the polarizer according to the present invention, wherein the polarizer is disposed at the boundary between the first supporting layer 11 and the polarizing layer 12;

FIG. 1(c) is a schematic view illustrating the pattern unit with the coding arrangement formed on the polarizer according to the present invention, wherein the polarizer is disposed at the boundary between the second supporting layer 13 and the polarizing layer 12;

FIG. 1(d) is a schematic view illustrating the pattern unit with the coding arrangement formed on the polarizer according to the present invention, wherein the polarizer is disposed at the boundary between the second supporting layer 13 and the adhesion layer 14;

FIG. 1(e) is a schematic view illustrating the pattern unit with the coding arrangement formed on the polarizer according to the present invention, wherein the polarizer is disposed at the boundary between the adhesion layer 14 and the separating layer 15;

FIG. 2 is a schematic view illustrating the pattern unit with the coding arrangement formed on the upper substrate corresponding to the black matrix region according to the present invention;

FIG. 3 is a schematic view illustrating the pattern unit with the coding arrangement formed on the upper substrate, but not limited to be corresponding to the black matrix region according to the present invention; and

FIG. 4 is a schematic view showing the pattern unit composed of a five-layer structure and formed on a substrate according to the present invention.

### DETAILED DESCRIPTION OF THE PREFERRED EMBODIMENT

The invention is described more specifically with reference to the following embodiments. It is to be noted that the following descriptions of preferred embodiments of this invention are presented herein for the purpose of illustration and description only; it is not intended to be exhaustive or to be limited to the precise form disclosed.

In accordance with the coding arrangement of the present invention, the pattern units arranged with the columns and the rows are formed on a plane of the display, wherein the pattern units can be identified by the optical method (such as the reflection of the infrared ray). The distance between the centers of the two adjacent pattern units is the constant C1, and the distance between the two adjacent rows is the constant C2. The shape of the pattern unit can be but not limited to a circle, a square, a rectangle, a hexagon or a polygon. In the embodiment of the present invention, the pattern unit is a circle, wherein the diameter of the circle is D, the C1 is equal to 4 D, the C2 is equal to 3.5 D, and D is ranged from about 5 micrometers to about 100 micrometers.

Furthermore, the coding method for the identification of the touched position is usually based on the specific program, so as to delete certain selected pattern units from the original pattern units in columns and rows in sequence, or to form a satellite pattern unit around the selected original pattern unit for the identification, or to change the original pattern units from the order arrangement to the arrangement where certain selected order unit is changed into disorder one.

For identifying the touched position, a charge coupled device (CCD) or a CMOS sensor array is used for reading all pattern units in an area of about 1 millimeter in diameter, and then the decoding process is performed by the program to identify the touched position. The CCD and the CMOS sensors are located in the light pen, and moreover the light pen has an infrared ray LED or a laser source for emitting the light to the coding arrangement. Consequently, the light is reflected by the coding arrangement and detected by the CCD or the CMOS sensor array.

The present invention provides a touch-input-integrated liquid crystal display panel having pattern units with the coding arrangement for intensively reflecting the infrared ray of the light incident on the panel, and the touched position is identified by receiving the reflected infrared ray and decoding the coding arrangement. To this end, the pattern units with the coding arrangement should be integrated into the liquid crystal display panel as following descriptions. In the embodiments of the present invention, the pattern units are circular form for simplification; however, the pattern units are not limited to the circular form.

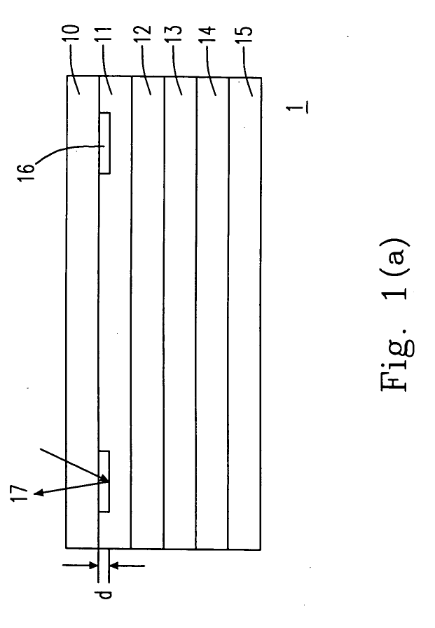

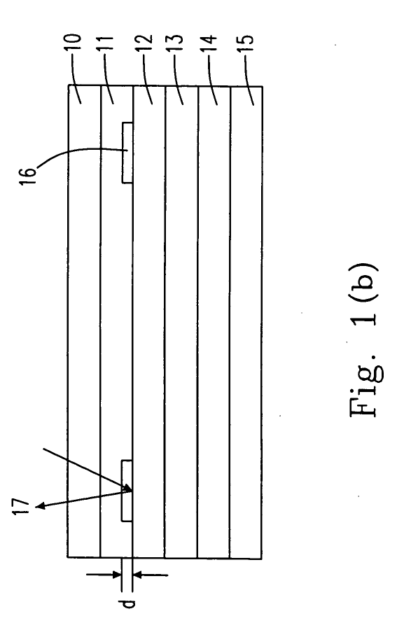

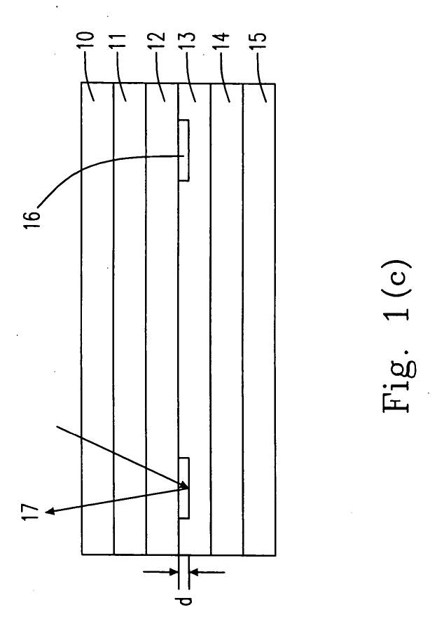

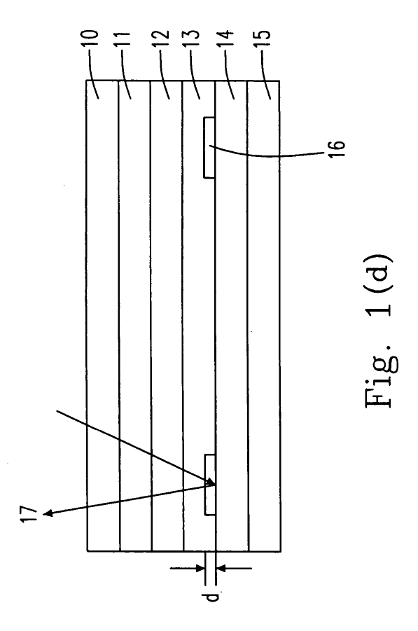

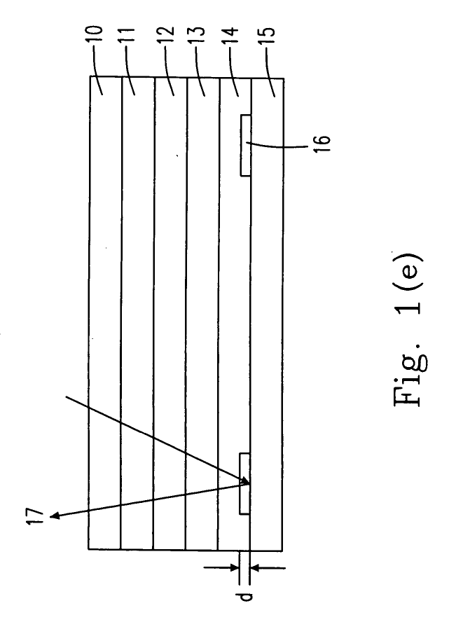

The pattern units with the coding arrangement are formed on the polarizer of the liquid crystal display panel. Please refer to FIG. 1(a), which is the schematic view showing the pattern units with the coding arrangement formed on the polarizer. As shown in FIG. 1(a), the polarizer 1 includes the protective layer 10, the first supporting layer 11 having the triacetate cellulose (TAC) as the main component, the polarizing layer 12, the second supporting layer 13, the adhesion layer 14 and the separating layer 15. The pattern unit 16 can be disposed at the boundary between the first supporting layer 11 and the protective layer 10 as shown in FIG. 1(a), disposed at the boundary between the supporting layer 11 and the polarizing layer 12 as shown in FIG. 1(b), disposed at the boundary between the second supporting layer 13 and the polarizing layer 12 as shown in FIG. 1(c), disposed at the boundary between the supporting layer 13 and the adhesion layer 14 as shown in FIG. 1(d), or disposed at the boundary between the adhesion layer 14 and the separating layer 15 as shown in FIG. 1(e).

The depth of the pattern unit 16 is d as shown in FIGS. 1(a)-1(e). The pattern unit 16 is a recess or a layer of a film or films having a denser optical medium or a less dense optical medium, and the depth d multiplied by the refractive index of the medium is about (N+¼)-folds of a wavelength of the infrared ray 17, wherein N is an integer greater than −1.

The refractive index of the pattern unit 16 for the infrared ray can be about 1, and is less than the refractive indices of the two layers adjacent to the pattern unit 16, so that the intensively reflected infrared ray 17 is formed due to the constructive interference. In addition, a proper N value is selected to minimize visible-light (not shown) reflection.

When the pattern unit 16 is disposed on the first supporting layer 11 and below the protective layer 10 as shown in FIG. 1(a), and the protective layer 10 is torn by the user, the pattern unit 16 has the less dense optical medium or air. Consequently, the depth d multiplied by the refractive index of the medium is about (N+½)-folds of a wavelength of the infrared ray 17, wherein N is an integer greater than −1.

In addition, a single-layer structure or a multiple-layer structure (not shown) can be formed on the location of the pattern unit 16 to reflect the reflected infrared ray 17 intensively and weakening the visible-light reflection to an acceptable level.

In addition, the pattern unit 16 can be replaced with a single-layer structure or a multiple-layer structure with at least one layer is made of cholesteric liquid crystalline material, and thus optical quality of the single-layer structure or the multiple-layer structure is to have a substantial reflection in the infrared region and reduced reflection in the visible region.

Moreover, the pattern unit 16 can be replaced with a single-layer or multiple-layer cholesteric liquid crystalline films, wherein at least a pitch length of the cholesteric liquid crystalline film multiplied by the average reflective index of the cholesteric liquid crystalline film is approximately equal to the wavelength of the infrared ray 17. Furthermore, the cholesteric liquid crystalline film has low reflection for the visible light.

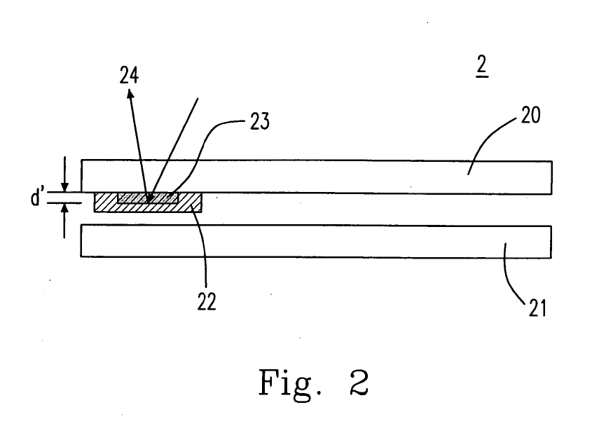

The pattern unit with the coding arrangement is disposed on the upper substrate corresponding to the black matrix (BM) surrounding display pixels. Please refer to FIG. 2, which is a schematic view showing the pattern unit with the coding arrangement disposed on the upper substrate corresponding to the black matrix. As shown in FIG. 2, it is shown for the simplification that the liquid crystal display panel 2 includes the upper substrate 20, the lower substrate 21, the black matrix 22 and the pattern unit 23, which is formed on the upper substrate 20 corresponding to the black matrix 22 and away from the regions of pixel (not shown) on the liquid crystal display panel 2.

The pattern unit 23 can be a single-layer structure or a multiple-layer structure. When the pattern unit 23 is the single-layer structure made of ITO, the amorphous silicon or SiNₓ, the pattern unit 23 can be designed to reflect infrared light substantially. Compared with the black matrix 22 made of Cr₂O₃ or resin and compared with the substrates 20 and 21 made of glass or plastics, the reflective layer has the denser optical medium. The refractive index of the reflective layer (pattern unit 23) for the infrared ray is larger than the refractive indices of the two layers adjacent to the reflective layer. The depth d′ of the reflective layer multiplied by the refractive index of the reflective layer is about (N+¼)-folds of a wavelength of the infrared ray 24, wherein N is an integer greater than −1. The intensively reflected infrared ray 24 is formed due to the constructive interference. In addition, when a proper N value is selected, the minimum visible light (not shown) is reflected.

When the reflective layer is the single-layer structure made of SiOₓ or air, compared with the black matrix 22 made of Cr₂O₃ or resin and compared with the substrates 20 and 21 made of glass or plastics, the reflective layer has the less dense optical medium. The refractive index of the reflective layer (pattern unit 23) for the infrared ray is less than the refractive indices of the- two layers adjacent to the reflective layer. The depth d′ of the reflective layer multiplied by the refractive index of the reflective layer is about (N+¼)-folds of a wavelength of the infrared ray 24, wherein N is an integer greater than −1. The intensively reflected infrared ray 24 is formed due to the constructive interference. In addition, when a proper N value is selected, the minimum visible light (not shown) is reflected.

Similarly, when the pattern unit 23 is the multiple-layer structure, the intensively reflected infrared ray 24 is formed and the minimum visible light (not shown) is reflected.

Certainly, the pattern unit 23 can be formed on top of the upper substrate 20, and the available optical effects are similar to those shown in FIG. 2.

### THE PREFERRED EMBODIMENT I

The wavelength of the infrared ray 24 is 910 nm, the central wavelength of the visible light is 550 nm, the reflective layer is the single layer made of the amorphous silicon, wherein the refractive index of the amorphous silicon for the infrared ray 24 is 3.70, and the thickness of the reflective layer is 61.5 nm or 307 nm. Accordingly, the reflection of the infrared ray is substantial, and the reflection level of the visible light is acceptably weak.

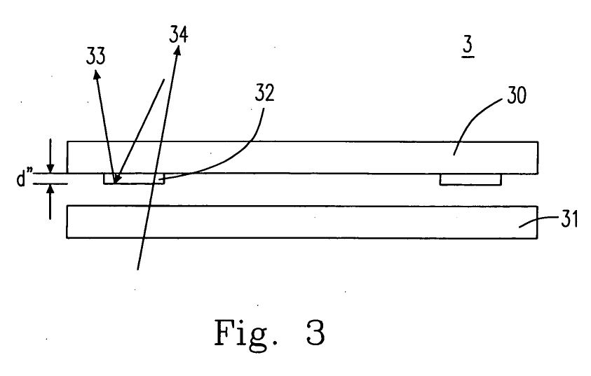

The pattern unit with the coding arrangement is disposed on the upper substrate of the liquid crystal display panel, but not limited to be corresponding to the black matrix region. Please refer to FIG. 3, which is the schematic view showing the pattern unit with the coding arrangement formed on the upper substrate of the liquid crystal display panel, but not limited to be formed on the black matrix region. As shown in FIG. 3, it is shown for the simplification that the liquid crystal display panel 3 includes an upper substrate 30, the lower substrate 31 and the pattern unit 32. In this case, it is to be noted that the infrared ray 33 is well reflected from the liquid crystal display panel 3, and moreover the liquid crystal display panel 3 has high transmittance for the visible light 34.

The pattern unit 32 can be a single-layer structure or a multiple-layer structure. When the pattern unit 32 is the single-layer structure made of ITO or SiNₓ, the pattern unit 32 can be designed to reflect a substantial amount of the infrared light. Compared with the black matrix made of Cr₂O₃ or resin and compared with the substrates 30 and 31 made of glass or plastics, the reflective layer has the denser optical medium.

The refractive index of the reflective layer (the pattern unit 32) for the infrared light is larger than the refractive indices of the two layers adjacent to the reflective layer. The depth d″ of the reflective layer multiplied by the refractive index of the reflective layer is about (N+¼)-folds of a wavelength of the infrared ray 33, wherein N is an integer greater than −1. The intensively reflected infrared ray 33 is formed due to the constructive interference. In addition, the reflective layer is made of the transparent material relative to the visible light 34, so that when a proper N value is selected, a minimum reflection of visible light (not shown) is achieved, and the visible light transmission is not significantly reduced.

When the reflective layer (the pattern unit 32) is the single-layer structure made of SiOₓ or air, compared with the black matrix made of Cr₂O₃ or resin and compared with the substrates 30 and 31 made of glass or plastics, the reflective layer has the less dense optical medium. The depth d″ of the reflective layer multiplied by the refractive index of the reflective layer is about (N+¼)-folds of a wavelength of the infrared ray 33, wherein N is an integer greater than −1. The intensively reflected infrared ray 33 is formed due to the constructive interference. In addition, the reflective layer is made of the transparent material relative to the visible light 34, so that when a proper N value is selected, the minimum reflection of visible light is achieved, and the visible light transmittance is not significantly reduced.

Similarly, when the pattern unit 32 is the multiple-layer structure, the intensively reflected infrared ray 33 is formed, a minimum reflection of visible light is reflected, and the visible light transmittance is not significantly reduced.

Certainly, the pattern unit 32 can be formed on top of the upper substrate 30, and the available optical effects are similar to those shown in FIG. 3.

### THE PREFERRED EMBODIMENT II

The wavelength of the infrared ray 33 is 910 nm, the central wavelength of the visible light is 550 nm, the reflective layer is the single layer made of ITO, wherein the refractive index of the ITO for the infrared ray 33 is 1.85, and the thickness of the reflective layer is 123 nm or 369 nm. Accordingly, the reflection of the infrared ray is substantial, and the reflection level of the visible light is acceptably weak.

### THE PREFERRED EMBODIMENT III

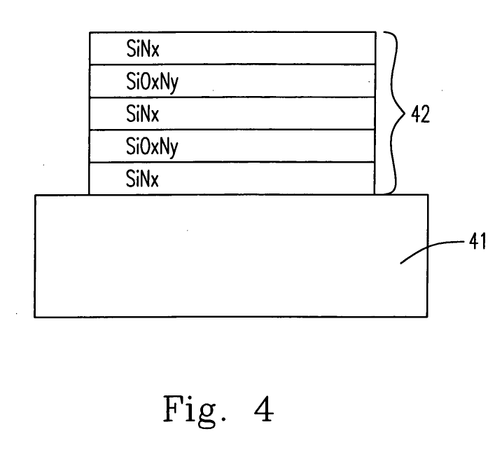

Please refer to FIG. 4. The pattern unit 42 is composed of a five-layer structure made of SiNₓ and SiOₓN_{y} alternatively and formed on a substrate 41 as shown in FIG. 4. In this embodiment, the wavelength of the infrared ray is 910 nm, and the central wavelength of the visible light is 550 nm. The refractive indexs of the SiNₓ and SiOₓN_{y} for the infrared ray are 1.90 and 1.57, respectively. The thickness of each layer from the layer near the substrate 41 to the top layer is about 127 nm, 146 nm, 113 nm, 146 nm, 127 nm, respectively. Accordingly, the reflection of the infrared ray is substantial, and the reflection level of the visible light is acceptably weak.

Accordingly, the present invention provides the touch-input-integrated liquid crystal display panel including the pattern unit with the coding arrangement for intensively reflecting the infrared ray incident on the panel, and thereby a position of the panel where the infrared ray is incident upon is obtained by receiving the reflected infrared ray and decoding the coding arrangement. Since the pattern unit is integrated into the liquid crystal display panel, the panel has great optical quality and the coding arrangement is well protected. Furthermore, compared with the conventional liquid crystal display panel with added on the external touch input device, the touch-input-integrated liquid crystal display panel of the present invention is lighter.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A liquid crystal display panel, comprising:
at least a pattern unit with a coding arrangement, wherein an infrared ray incident on said liquid crystal display panel is intensively reflected by said pattern unit, and a position of said liquid crystal display panel, where said infrared ray is incident upon is obtained by receiving said reflected infrared ray and decoding said coding arrangement.

2. The liquid crystal display panel according to claim 1, further comprising a polarizer having said pattern unit disposed thereon.

3. The liquid crystal display panel according to claim 2, wherein said polarizer comprises at least a supporting layer and an adhesion layer, and said pattern unit is disposed on one of said supporting layer and said adhesion layer.

4. The liquid crystal display panel according to claim 3, wherein said pattern unit is a recess having one of a denser optical medium and a less dense optical medium relative to said supporting layer and said adhesion layer, wherein a depth of said recess multiplied by a refractive index of said medium is about (N+¼)-folds of a wavelength of said received infrared ray and said N is an integer greater than −1.

5. The liquid crystal display panel according to claim 3, wherein said pattern unit further comprises one of a single-layer structure and a multiple-layer structure to reflect a substantial amount of said reflected infrared ray and a small amount of visible light.

6. The liquid crystal display panel according to claim 3, wherein said pattern unit is a layer of film or films disposed on an upper side of said supporting layer and having one of a denser optical medium and a less optical medium relative to said supporting layer and said adhesion layer, wherein a depth of said layer multiplied by a refractive index of said medium is about (N+½)-folds of a wavelength of said received infrared ray and said N is an integer greater than −1.

7. The liquid crystal display panel according to claim 3, wherein said pattern unit is one of a single-layer structure and a multiple-layer structure, and said pattern unit and rest parts of said liquid crystal display panel other than said pattern unit have an approximately identical visible light transmittance.

8. The liquid crystal display panel according to claim 7, wherein said single-layer structure and said multiple-layer structure are made of at least a cholesteric liquid crystalline film, and the pitch length of said cholesteric liquid crystalline film multiplied by the average refractive index of said film is approximately equal to a wavelength of said received infrared ray.

9. A liquid crystal display panel, comprising:
a lower substrate and an upper substrate including a pattern unit with a coding arrangement, wherein an infrared ray of a light incident on said liquid crystal display panel is intensively reflected by said pattern unit and a position of said liquid crystal display panel, where said infrared ray is incident upon is obtained by receiving said reflected infrared ray and decoding said coding arrangement.

10. The liquid crystal display panel according to claim 9, wherein said pattern unit is one of a single-layer structure and a multiple-layer structure.

11. The liquid crystal display panel according to claim 10, further comprising a black matrix surrounding transmitting display pixels, wherein said pattern unit is disposed on said upper substrate corresponding to said black matrix and away from transmitting windows of said display pixels.

12. The liquid crystal display panel according to claim 9, wherein said multiple-layer structure comprises SiNₓ and SiOₓN_{y}.

13. The liquid crystal display panel according to claim 9, further comprising a black matrix surrounding transmitting display pixels, wherein said pattern unit is disposed on said upper substrate, and said pattern unit has a relative high transmittance for a visible light of said light.

14. The liquid crystal display panel according to claim 10, wherein said pattern unit has a denser optical medium than one of said black matrix and said upper substrate, and said pattern unit is made of one selected from a group consisting of an ITO, an amorphous silicon and a SiNₓ.

15. The liquid crystal display panel according to claim 14, wherein a depth of said pattern unit multiplied by a refractive index of said denser optical medium is about (N+¼)-folds of a wavelength of said received infrared ray and said N is an integer greater than −1.

16. The liquid crystal display panel according to claim 13, wherein said pattern unit has a less dense optical medium than one of said black matrix and said upper substrate, and said pattern unit is made of one of a SiOₓ and air.

17. The liquid crystal display panel according to claim 16, wherein a depth of said pattern unit multiplied by a refractive index of said less dense optical medium is about (N+¼)-folds of a wavelength of said received infrared ray, and said N is an integer greater than −1.

18. The liquid crystal display panel according to claim 10, wherein said single-layer structure and said multiple-layer structure are made of at least a cholesteric liquid crystalline film, and a pitch length of said cholesteric liquid crystalline film multiplied by the average refractive index of said film is approximately equal to a wavelength of said received infrared ray.

19. A polarizer, comprising at least a pattern unit with a coding arrangement, wherein an incident infrared ray of a light on said polarizer is reflected substantially by said pattern unit.

20. A substrate, comprising at least a pattern unit with a coding arrangement, wherein an infrared ray of a light incident on said substrate is intensively reflected by said pattern unit.
